(19) United States
(12) Patent Application Publication
(10) Pub. No.: US 2006/0236970 A1
(43) Pub. Date: Oct. 26, 2006

(54) Control system for vehicle

(75) Inventors: Takahiro Inada, Hiroshima (JP); Yasushi Hamada, Hiroshima (JP)

Correspondence Address: NIXON PEABODY, LLP, 401 9TH STREET, NW, SUITE 900, WASHINGTON, DC, 20004-2128, US

(73) Assignee: MAZDA MOTOR CORPORATION, Hiroshima (JP)

(21) Appl. No.: 11/398,715

(22) Filed: Apr. 6, 2006

(30) Foreign Application Priority Data
Apr. 20, 2005 (JP) 2005-122362
Apr. 27, 2005 (JP) 2005-129334

(51) Int. Cl. F02D 45/00; B60R 25/04

(52) U.S. Cl. 123/179.4; 307/10.3

(57) ABSTRACT

A control unit automatically stops an engine when a vehicle is stopped and automatically starts the engine in a case where operation for a vehicle start is conducted by a passenger or a specified emergency start is required. Herein, in the case where the operation for the vehicle start is conducted by the passenger, the engine is automatically started when ID verification with a portable device is confirmed, and in the case where the specified emergency start is required, the engine is automatically started without the confirmation of the ID verification with the portable device. Accordingly, a proper antitheft function of a smart engine starter (SES) system and a proper engine-start function of an idling stop start (ISS) system.

### BACKGROUND OF THE INVENTION

The present invention relates to a control system for a vehicle that comprises both an idling stop start system and a smart engine starter system.

Conventionally, a vehicle with the idling stop start system, which aims at improving a fuel economy, reducing an exhaust emission, suppressing vibrations and noises and so forth, is known. For example, Japanese Patent Laid-Open Publication No. 10-299531 discloses the vehicle in which the engine is automatically stopped (idling stop) when the driver steps off the clutch pedal at the zero-vehicle speed and then the engine is restarted (idling start) when the clutch pedal is pressed on again. Further, it is also known that the engine is automatically started in a case where a specified emergency start is required, for example, when a vehicle's battery capacity decreases below a specified capacity during the engine stop. Likewise, it is known that the engine is automatically started for an emergency start when a vehicle's brake boost decreases below a specified brake boost during the engine stop.

Meanwhile, a vehicle with the smart engine starter system that aims at a vehicle antitheft is known. For example, Japanese Patent Laid-Open Publication No. 2003-269019 discloses the vehicle in which the wireless-signal communication is conducted between the onboard device and the portable device and the engine's start is granted when ID code verification through this communication is confirmed.

Herein, the vehicle equipped with the above-described both systems, the idling stop start system and the smart engine starter system, have the following problems. Hereinafter, the idling stop start system is referred to as “ISS,” and the smart engine starter system is referred to as “SES.” For example, there would occur a case where while the engine is stopped according to the ISS system in a parking lot or somewhere, the passenger misunderstands that the engine has been stopped because of the engine stop operation being conducted by the passenger and then leaves the vehicle carrying the portable device. In this case, any person not carrying the portable device could get on the vehicle and conduct operation for the vehicle start. Thereby, the vehicle theft might occur. In order to prevent this situation, the confirmation of ID verification may be required when the engine is started according to the ISS system, like the engine start according to the SES system.

Meanwhile, there would occur a problem that the engine start according to the emergency start of the ISS system is not conducted properly. Namely, for example, while the engine is stopped according to the ISS system in the parking lot or somewhere, the passenger is having a rest with some electric devises operating, such as an air conditioner and/or an audio device. In this case, if the battery capacity decreases improperly, the ISS system is going to conduct the emergency start of the engine. Herein, if there happens any problems with the ID verification with the portable device, the engine would not be properly started and thereby the battery would go dead (discharged). The above-described problems of the ID verification with the portable device may be caused by some circumstances of the vehicle stopped (e.g., the wireless-signal communication between the onboard device and the portable device may be disturbed by electromagnetic noises generated from a broadcasting station located nearby), location of the portable device in the vehicle (e.g., the signal (request signal) from the onboard device may not reach properly the portable device that is placed in a bag, deteriorating proper communications between the onboard device and the portable device), the capacity of a battery of the portable device (e.g., the intensity of ID signal from the portable device with the low battery capacity may becomes too weak to have proper communications between them), or the like. Likewise, in the case where the brake boost decreases improperly, instead of the battery capacity, in the same situations described above, the engine may not be started properly, so that a pressing force required to step on the brake pedal that is required right after the vehicle start would become relatively heavy.

### SUMMARY OF THE INVENTION

The present invention has been devised in view of the above-described problems, and an object of the present invention is to provide a control system for a vehicle that can provide a proper antitheft function of the SES system and a proper engine-start function of the ISS system.

According to the present invention, there is provided a control system for a vehicle, comprising a smart engine starter control device, in which a start of an engine of the vehicle is granted when ID verification with a portable device operative to exchange wireless signals is confirmed in a case where an operation for an engine start is conducted by a passenger, and an idling stop start control device, in which the engine is automatically stopped when the vehicle is stopped and automatically started in a case where an operation for a vehicle start is conducted by the passenger or a specified emergency start is required,. wherein the idling stop start control device is configured such that in the case where the operation for the vehicle start is conducted by the passenger, the engine is automatically started at least when the ID verification with the portable device is confirmed, and in the case where the specified emergency start is required, the engine is automatically started without the confirmation of the ID verification with the portable device or on a condition of the confirmation of the ID verification along with a specified control to enhance a function of the ID verification.

Thereby, according to the vehicle equipped with both ISS system and SES system, the engine's start according to the vehicle start operation by the passenger is executed when the ID verification with the portable device is confirmed. Accordingly, even if any persons who do not carry the portable device get on the vehicle and try to move the vehicle while the passenger carrying the portable device is out and away from the vehicle, the engine start is prohibited, thereby securing the antitheft function of the SES system properly.

Meanwhile, the engine's start according to the emergency start requirement of the battery capacity decrease or the brake boost decrease is executed without the confirmation of the ID verification with the portable device or on the condition of the confirmation of the ID verification along with the specified control to enhance the function of the ID verification. Accordingly, even if there would occur any problems with the verification by the portable device, the proper engine start can be maintained, thereby securing the engine start function of the ISS system properly and avoiding the battery discharge or the heavy brake operation at the engine start.

Herein, in the case where the engine is automatically started on the condition of the confirmation of the ID verification along with the specified control to enhance the function of the ID verification, this specified control to enhance the function of the ID verification comprises at least one of a signal-intensity increase control and a signal-threshold decrease control for the exchanged wireless signals of the portable device. Thereby, the engine's start according to the emergency start requirement is also executed with the confirmation of the ID verification with the portable device. Thereby, the antitheft function of the SES system can be strengthened further, and the control-to enhance the ID verification function can be properly attained.

According to an embodiment of the present invention, where the engine is automatically started without the confirmation of the ID verification with the portable device, the idling stop start control device is configured such that after the engine is automatically started according to the requirement of the specified emergency start and in the case where the operation for the vehicle start is conducted by the passenger, the vehicle is prohibited from starting when the ID verification with the portable device is not confirmed.

Thereby, after the engine is automatically started according to the emergency start requirement and when the operation for the vehicle start is conducted by the passenger, the vehicle is prohibited from starting when the ID verification with the portable device is not confirmed. Accordingly, it can be prevented that any persons not carrying the portable device starts the vehicle after the emergency start requirement is met (the battery capacity decrease, the brake boost decrease, etc.), thereby securing the antitheft function of the vehicle.

According to another embodiment of the present invention, where the engine is automatically started without the confirmation of the ID verification with the portable device, the idling stop start control device is configured such that after the engine is automatically started according to the requirement of the specified emergency start and when ID verification with the portable device is not confirmed, a specified alarm is conducted.

Thereby, after the engine is automatically started according to the emergency start requirement and when the ID verification with the portable device is not confirmed, the specified alarm is conducted. Accordingly, the passenger can be notified in advance of a situation where the vehicle may be prohibited from starting even if the vehicle start operation is conducted by the passenger while the ID verification with the portable device is not confirmed. Thereby, the passenger can be prevented properly from getting upset in or surprised with a situation where the engine has already started but the vehicle could not start (move) despite the vehicle start operation by the passenger.

Additionally, the above-described alarm becomes a warning that could urge any persons not carrying the portable device to leave the vehicle without trying the vehicle theft, or that could request the passenger carrying the portable device to remove any possible causes of the non-confirmation of the ID verification (such as, changing the position of the portable device, or replacing its battery by a new one).

According to another embodiment of the present invention, where the engine is automatically started without the confirmation of the ID verification with the portable device, there is further provided a passenger detecting device to detect an existence of the passenger in the vehicle, and the idling stop start control device is configured such that the engine start according to the requirement of the specified emergency start is restricted when the passenger's existence is not detected by the passenger detecting device.

Thereby, when the passenger's existence in the vehicle is not detected by the passenger detecting device, the engine staring is restricted, so that the engine can be prevented from being started automatically when passenger's existence is not detected after the passenger carrying the portable device gets off the vehicle. Thus, the antitheft function can be improved.

According to another embodiment of the present invention, where the engine is automatically started without the confirmation of the ID verification with the portable device, the idling stop start control device is configured such that an operation of an onboard electric device is restricted when the engine start is restricted.

Thereby, since the operation of the onboard electric device is restricted when the engine start is restricted, the battery discharge can be avoided in advance.

According to another embodiment of the present invention, where the engine is automatically started without the confirmation of the ID verification with the portable device, the idling stop start control device is configured such that when the passenger's existence is not detected by the passenger detecting device, the engine start is granted on a condition of the confirmation of the ID verification with the portable device.

Thereby, when the passenger's existence in the vehicle is not detected by the passenger detecting device, the engine start is granted on the condition of the confirmation of the ID verification with the portable device. Namely, even if any malfunctions or detecting mistakes would happen to the passenger detecting device, a situation where the engine can not be started with the vehicle start operation by the passenger during, for example, a vehicle stop for waiting for the light changed, can be prevented from happening. Also, even if any malfunctions or detecting mistakes would happen to the passenger detecting device and thereby the passenger's existence in the vehicle is not detected, the engine start is granted as long as the ID verification with the portable device is confirmed. Thereby, the battery discharge can be prevented properly, thereby securing the operation of the onboard electric devices, and the brake boost can be prevented from decreasing inappropriately. Herein, since the ID verification has been already confirmed, the grant of engine start would not cause the vehicle-theft problem.

According to another embodiment of the present invention, where the engine is automatically started without the confirmation of the ID verification with the portable device, there is further provided a restriction cancel device to cancel restrictions of the engine start and the onboard-electric-device operation, which is to be operated by the passenger.

Thereby, since there is provided the cancel switch to cancel restrictions of the engine start and the onboard-electric-device operation by the control unit, the engine can be operated by the passenger operating this cancel switch. Thereby, even in a case, for example, where the passenger goes out of the vehicle and the onboard electric devices, such as the audio device, some equipments connected to cigar-lighter outlet via a cable, are used for a long period of time, the operation of these devices can be attained properly with the function of the cancel switch and thus the utility of the vehicle can be improved.

Other features, aspects, and advantages of the present invention will become apparent from the following description which refers to the accompanying drawings. BRIEF DESCRIPTION OF THE DRAWINGS

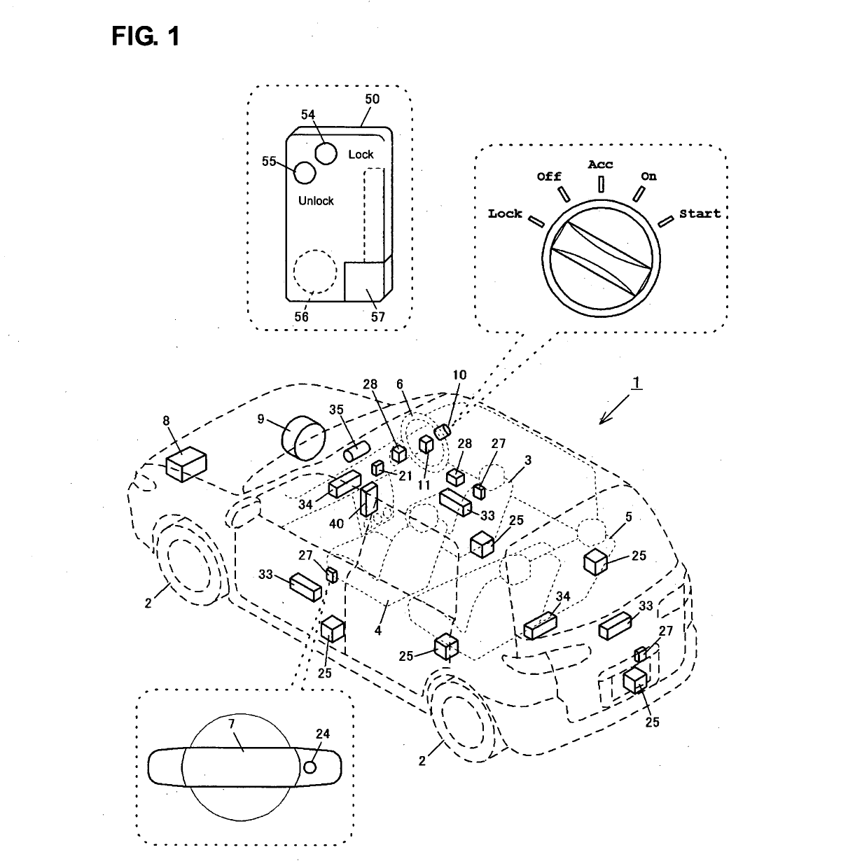

FIG. 1 is a perspective view showing major parts of a vehicle according to an embodiment of the present invention.

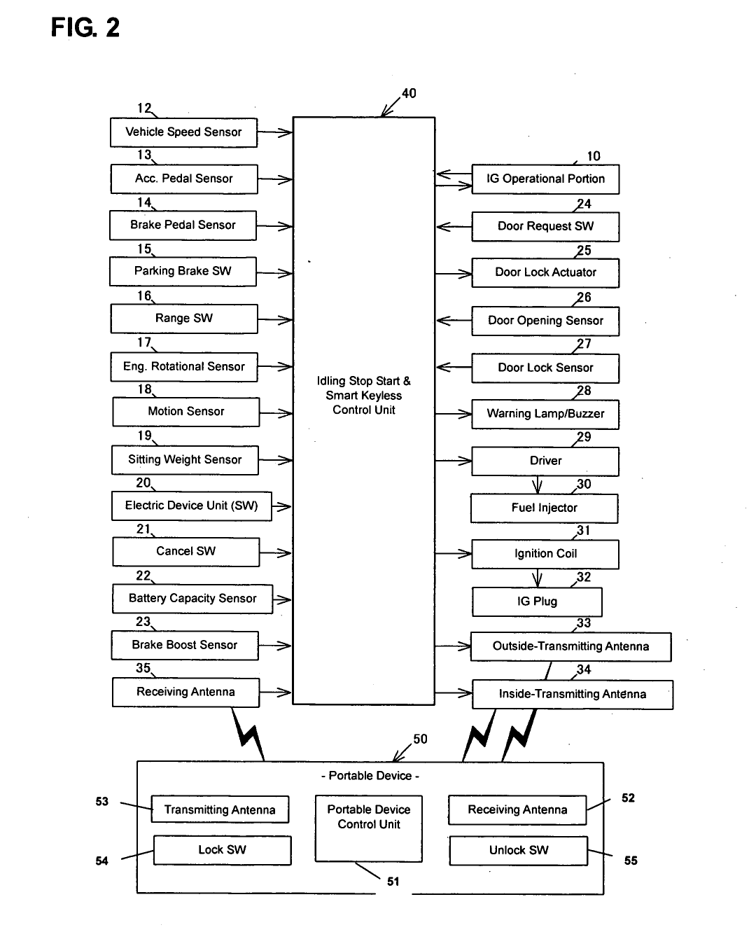

FIG. 2 is a control system diagram of the vehicle.

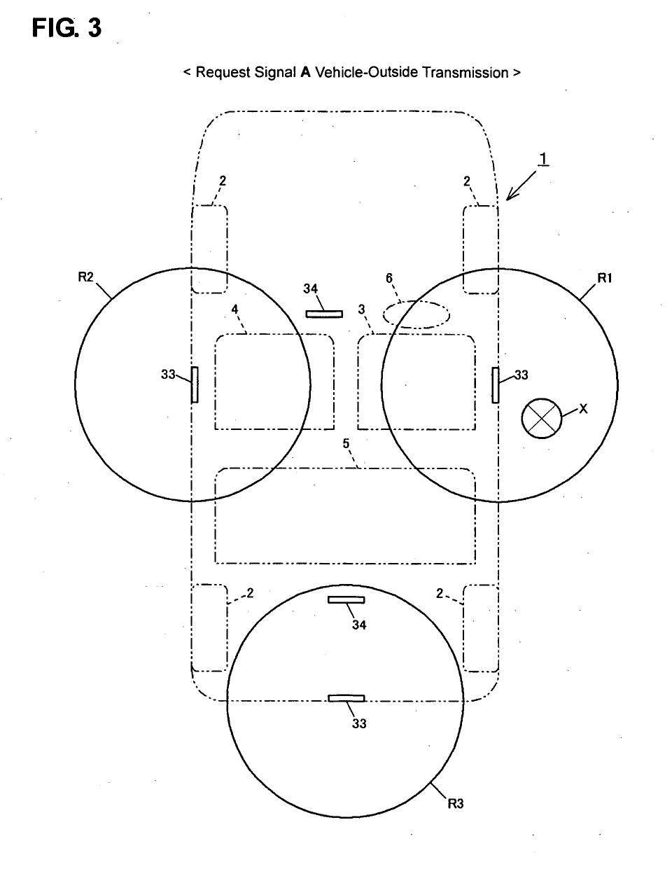

FIG. 3 is a plan view showing detecting areas of signal outside-transmitting antennas of the vehicle.

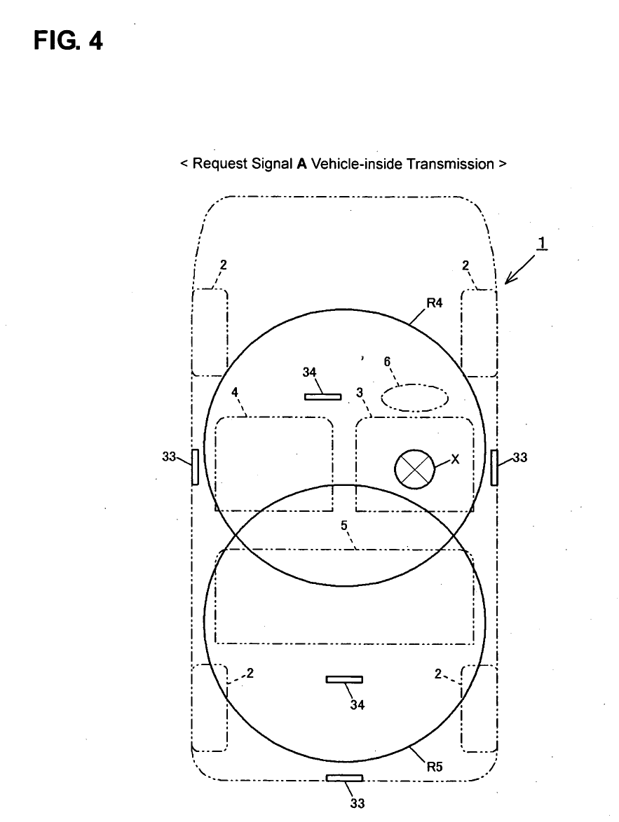

FIG. 4 is a plan view showing detecting areas of signal inside-transmitting antennas of the vehicle.

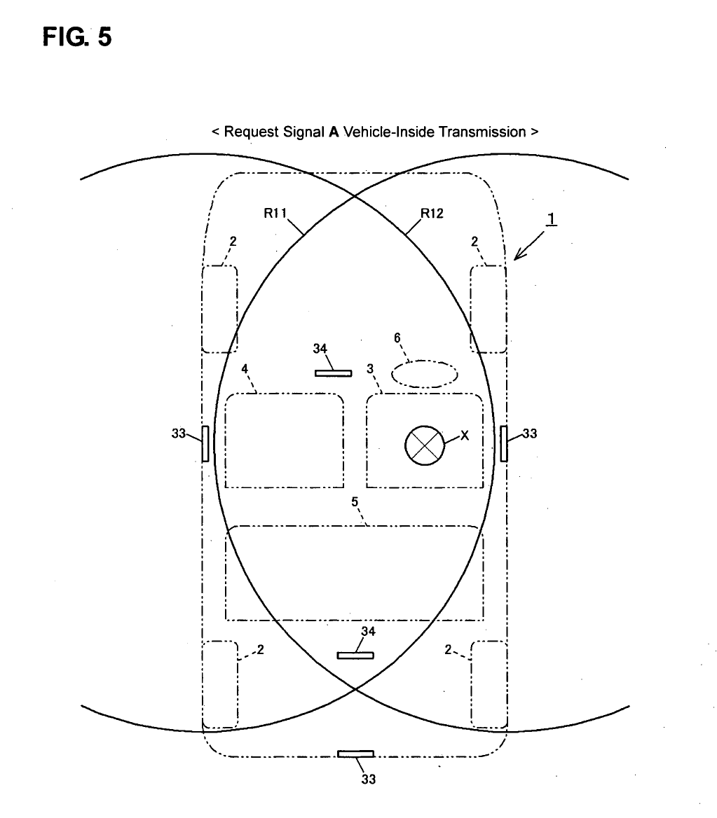

FIG. 5 is a plan view showing enlarged detecting areas of the signal outside-transmitting antennas of the vehicle.

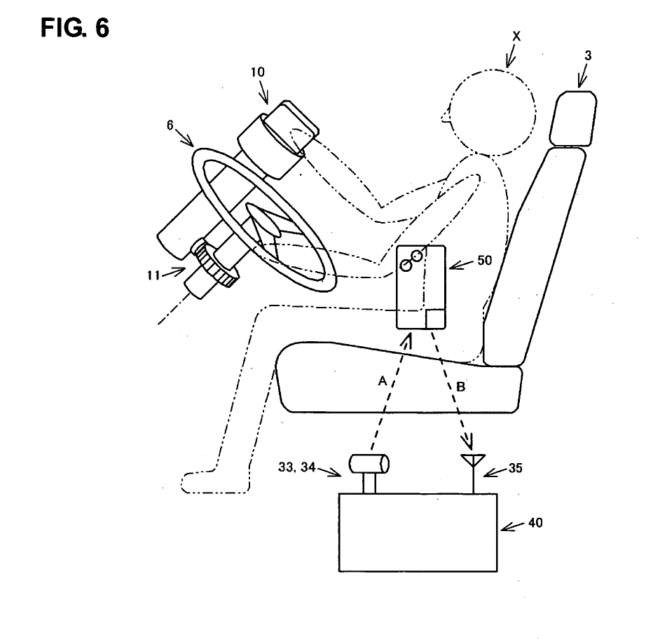

FIG. 6 is an explanatory diagram of an operation of SES system of the vehicle.

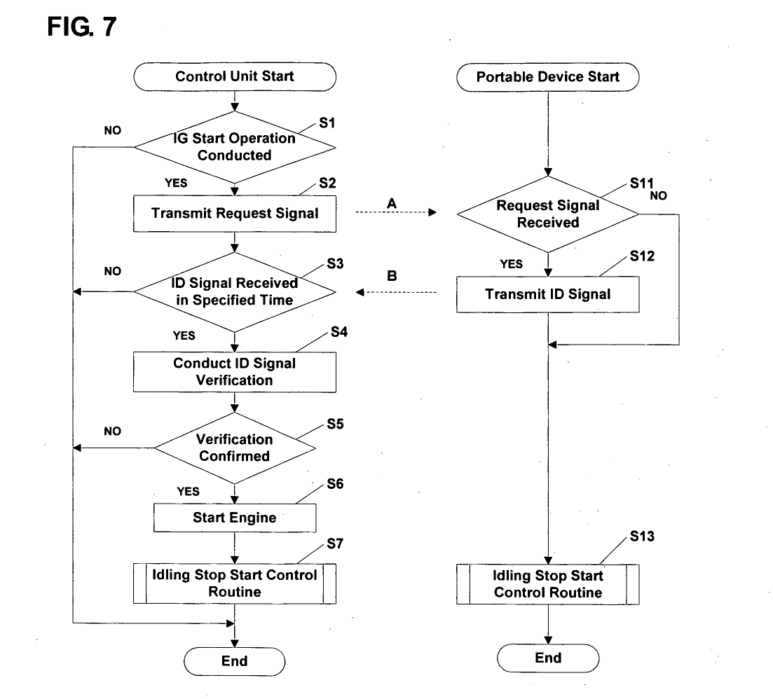

FIG. 7 is flowcharts of respective control operations of a control unit and a portable device of the vehicle.

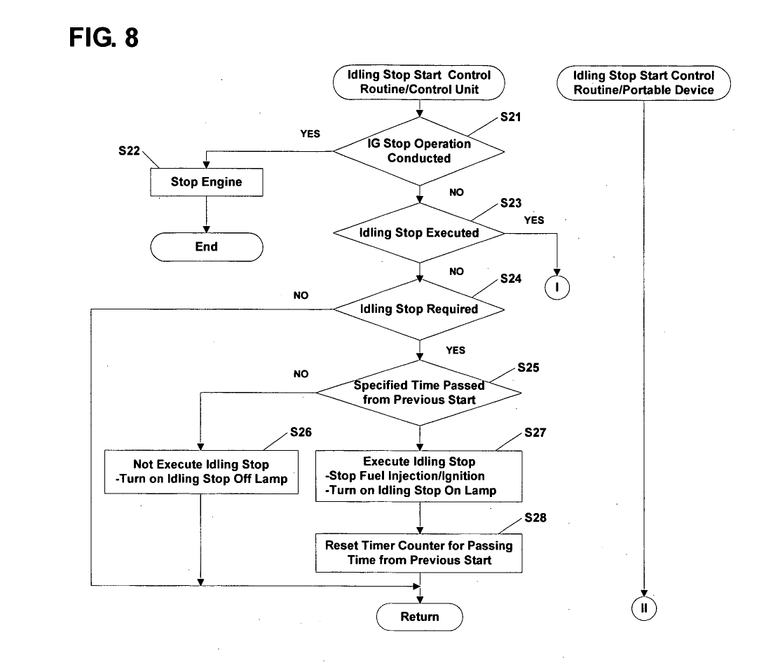

FIG. 8 is a flowchart of an exemplified specific operation of an idling stop start control of the vehicle.

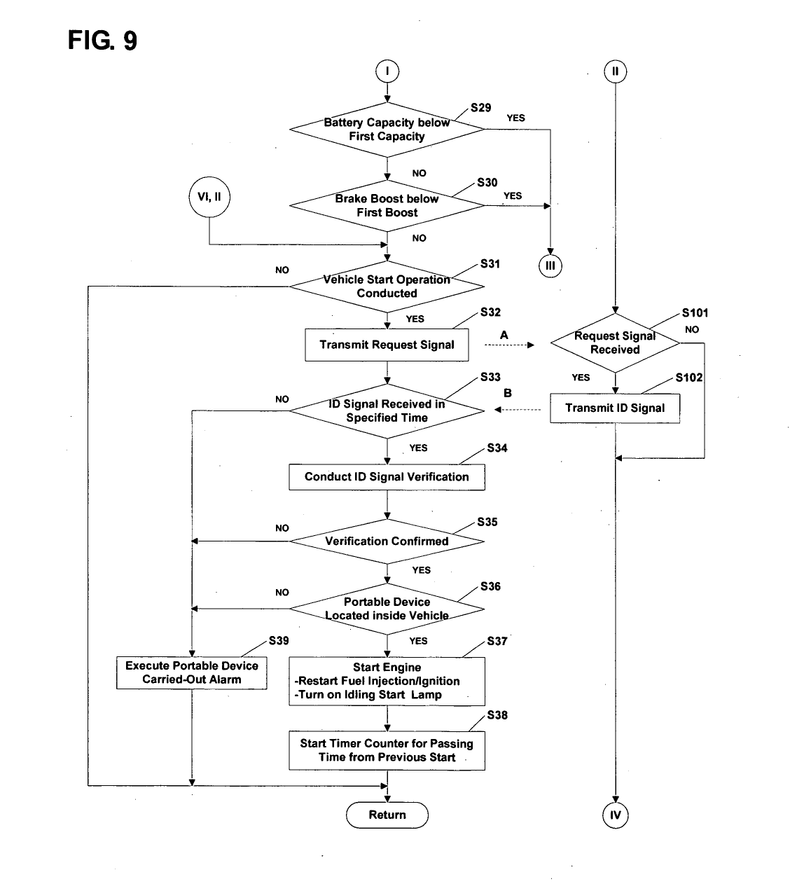

FIG. 9 is a flowchart following the flowchart in FIG. 8.

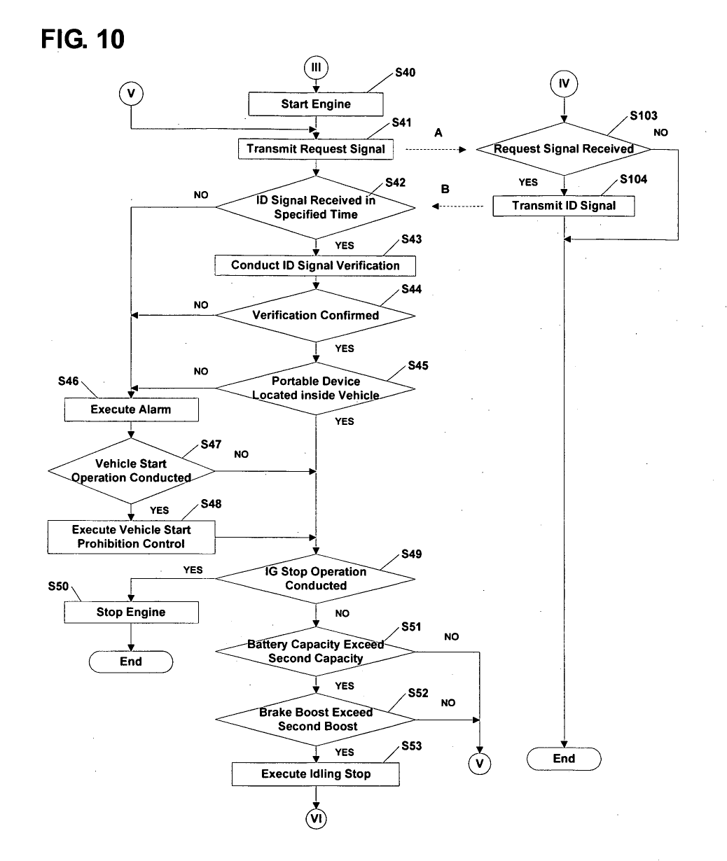

FIG. 10 is a flowchart following the flowchart in FIG. 9.

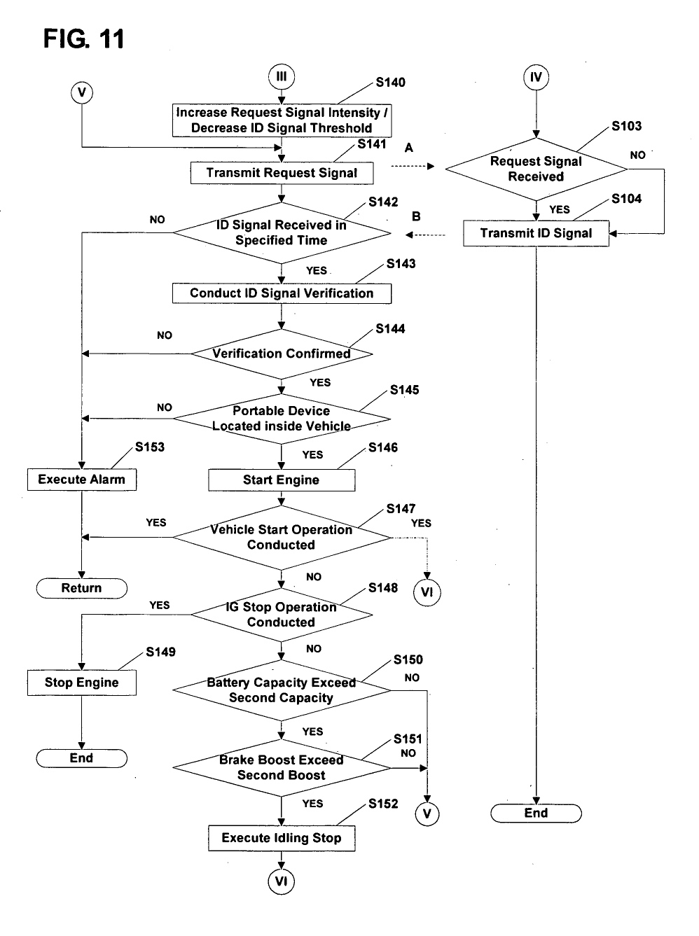

FIG. 11 is a flowchart of another exemplified specific operation of the idling stop start control of the vehicle, corresponding to FIG. 10.

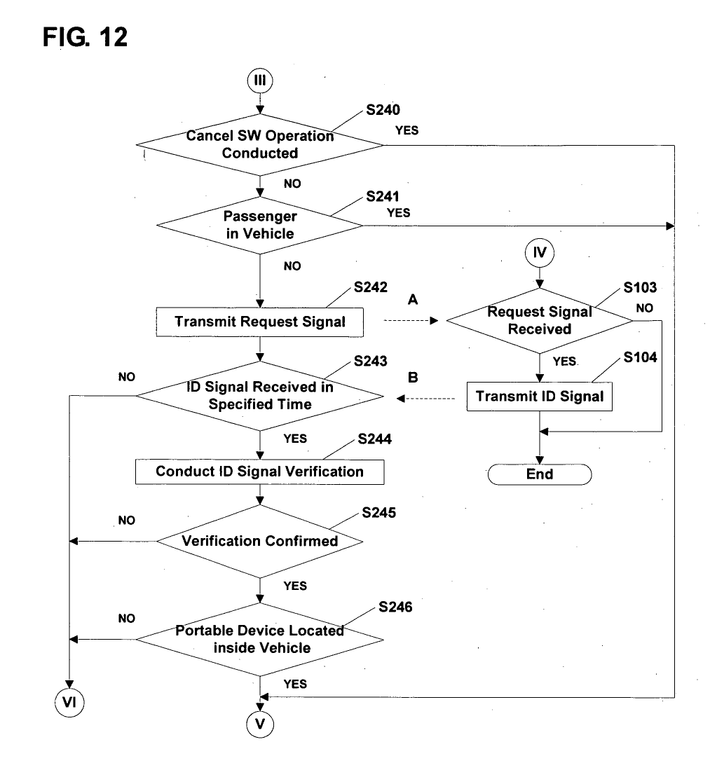

FIG. 12 is a flowchart of further another exemplified specific operation of the idling stop start control of the vehicle.

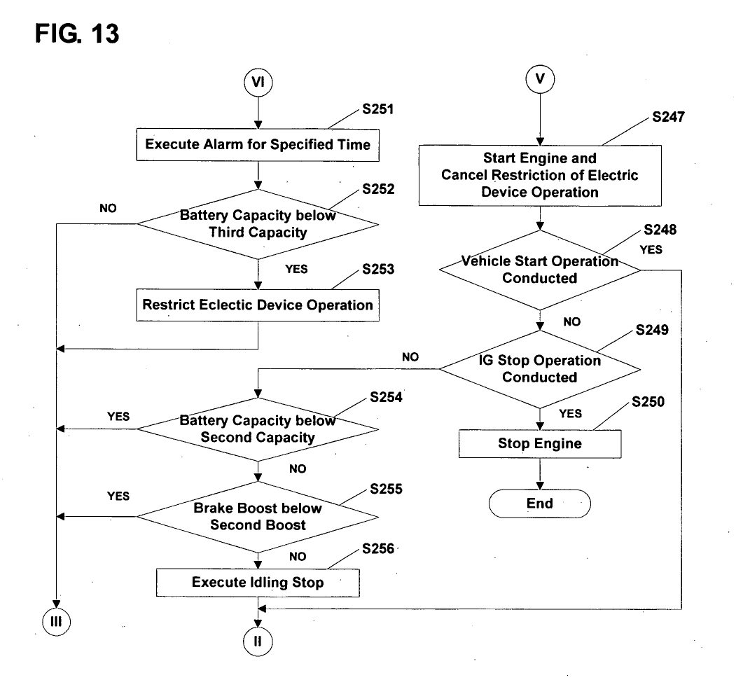

FIG. 13 is a flowchart following the flowchart in FIG. 12.

### DETAILED DESCRIPTION OF THE INVENTION

Hereinafter, preferred embodiments of the present invention will be described referring to the accompanying drawings.

In the embodiments, the present invention is adopted in a vehicle 1 shown in FIG. 1. The vehicle 1 is equipped with an idling stop start (ISS) system that can improve a fuel economy and the like, and a smart engine starter (SES) system that can prevent a vehicle theft and the like. It has an ignition operational portion 10 that is provided in front of a driver's seat 3. The ignition operational portion 10, as shown in FIG. 1, is selectable in a steering lock position (Lock), a steering lock cancel portion (Off), an accessory ON position (Acc), an ignition ON position (On), and an ignition start position (Start), respectively, and it can be pushed in its rotational axis direction. A steering wheel handle 6 is prevented from rotating with a mechanical lock by a steering lock mechanism 11 in the steering lock position. While, its rotation is free without the lock operation of the steering lock mechanism 11 in the steering lock cancel position. When a passenger tries to start an engine (not illustrated) for a vehicle start, the ignition operational portion 10 is positioned in the steering lock position (Lock), with its rotation prevented.

The vehicle 1 is equipped with a control unit 40 as an onboard signal transmission device (onboard device), which functions as a control unit for the ISS control and SEE control. The control unit 40 exchanges wireless signals with an portable signal device (portable device) 50. There are provided signal outside-transmitting antennas 33 . . . 33 at a driver's seat door, an assistant's seat door and a rear hatch, and signal inside-transmitting antennas 34, 34 at a front and a rear in the vehicle, which respectively transmit request signals from the onboard device 40. Meanwhile, there is provided a signal receiving antenna 35 at the front in the vehicle, which receives ID signal (a response signal including ID code that is peculiar (own) to each potable device 50) from the portable device 50. Further, there is provided a cancel switch 21 to cancel a restriction of the idling start by the control unit 40 at the front in the vehicle (corresponding to “a restriction cancel device” in the patent clam). Also, at outer knobs 7 . . . 7 of the driver's seat door, assistant's seat door and rear hatch (only the outer knob of the assistant's seat door is illustrated in FIG. 1) are provided door request switches 24 . . . 24 to be operated with pushing by a passenger located outside the vehicle, and door lock actuators 25 . . . 25 are provided near the driver's seat door, assistant's seat door and rear hatch. Furthermore, at a meter unit disposed in front of the driver's seat 3 is provided a warning lamp and buzzer 28 to alarm or notify the passenger in the vehicle.

Herein, the above-described control unit 40 corresponds to “a smart engine starter control device” and “an idling stop start control device” in the patent claims.

As shown in FIG. 2, the control unit 40 receives information data from the ignition operational portion 10, a vehicle speed sensor 12, an accelerator pedal sensor 13 to detect pressing of an accelerator pedal, a brake pedal sensor 14 to detect a brake pedal, a parking brake switch 15 to turn ON according to an operation of the parking brake, a range switch 16 to detect a range selected position of the shift lever, an engine rotational sensor 17, a motion sensor 18 to detect a motion of the passenger by using a CCD camera, an infrared-rays sensor etc., which is provided at an upper portion in the vehicle, a sitting-weight detecting sensor 19 to detect a passenger's sitting weight for determining operation of an airbag operation, an electric-device unit 20 equipped with switches of respective electric devices such as air conditioner, audio, which is provided at a console between the driver's seat and the assistant's seat, the above-described cancel switch 21, a battery sensor 22 to detect a capacity of a battery 8 (see FIG. 8), a brake boost sensor 23 to detect a boost in a brake booster 9 (see FIG. 1), a door request switch 24, a door opening detecting sensor 26 to detect an open state of the driver's seat door, assistant's seat door, rear seat door or rear hatch (this sensor may be comprised of a window opening detecting sensor to detect an open state of others such as windows of the vehicle 1, a courtesy-lamp switch, or the like), a door lock detecting sensor 27 to detect a lock state of the doors of the driver's seat door, assistant's seat door, rear seat door or rear hatch (this sensor may be comprised of a window opening detecting sensor to detect a closed state of others such as windows of the vehicle 1), the above-described signal receiving antenna 35 and the like. The control unit 40 outputs control signals to the ignition operational portion 10, the door lock actuators 25, the warning lamp and buzzer 28, a driver 29 of fuel injectors 30, an ignition coil 31 of ignition plugs 32, the signal outside-transmitting antennas 33 and the signal inside-transmitting antennas 34, respectively.

Herein, the above-described motion sensor 18, sitting-weight detecting sensor 19, electric-device unit 20, and door opening detecting sensor 26 correspond to “a passenger detecting device” in the patent claim.

Meanwhile, the portable device 50 which the passenger carries comprises a portable-device control unit 51, a signal receiving antenna 52, a signal transmitting antenna 53, a lock switch 54, and an unlock switch 55. The portable-device control unit 51 receives information data from the signal receiving antenna 52, lock switch 54 and unlock switch 55, and outputs a control signal to the signal transmitting antenna 53, thereby receiving a request signal from the onboard device 40 and transmitting ID signal to the onboard device 40. The portable device 50 is equipped with a battery 56 and an emergency key 57 for a system failsafe as shown in FIG. 1.

As shown in FIG. 3, when the request signal A is transmitted from the signal outside-transmitting antenna 33 . . . 33, detecting areas R1, R2 and R3 where the request signal A reaches are formed near the driver's seat door, assistant's seat door and rear hatch. Herein, when it is detected that the portable device 50 is within either one of these detecting areas R1, R2 and R3, the control unit 40 determines that the passenger X with the portable device 50 is located outside the vehicle. FIG. 3 shows that the passenger X is detected in the detecting area R1 near the driver's seat door. Herein, vehicle wheels 2 . . . 2, driver's seat 3, assistant's seat 4, rear seat 5 and steering handle 6 are illustrated together to show locations of the antennas 33 . . . 33 and the areas R1, R2 and R3.

Also, as shown in FIG. 4, when the request signal A is transmitted from the signal inside-transmitting antenna 34 . . . 34, detecting areas R4 and R5 where the request signal A reaches are formed at front and rear portions inside the vehicle, respectively. Likewise, when the portable device 50 is detected to be within either one of these detecting areas R4 and R5, the control unit 40 determines that the passenger X with the portable device 50 is located inside the vehicle. FIG. 4 shows that the passenger X is detected to be seated in the driver's seat 3 in the detecting area R4. Likewise, the vehicle wheels 2 . . . 2, driver's seat 3, assistant's seat 4, rear seat 5 and steering handle 6 are illustrated together to show locations of the antennas 34 . . . 34 and the areas R4 and R5.

Further, as shown in FIG. 5, the signal outside-transmitting antenna 33 . . . 33 at the driver's seat door and the assistant's seat door may be configured so as to have enlarged detecting areas R11, R12, so that an overlap area of these detecting areas R11, R12 can cover almost a whole area inside the vehicle. When the portable device 50 is detected to be within this overlap area, the control unit 40 determines that the passenger X with the portable device 50 is located inside the vehicle.

Next, the operation of SES system of the vehicle 1, i.e., the operation at the engine start by the passenger, will be described referring to FIG. 6. As described above, the ignition operational portion 10 is positioned in the steering lock position (Lock) at the engine start, with its rotation locked. First, the passenger X pushes the ignition operational portion 10. The control device 40 transmits the request signal A via the antennas 33, 34 in response to the pushing operation. The portable device 50 carried by the passenger X receives this request signal A and then transmits the ID signal B including its own ID code. The control unit 40 receives the ID signal B via the receiving antenna 35, and then determines whether or not this received ID code is identical to the regular ID code (ID verification is conducted). When these codes are identical (ID verification is confirmed), the control unit 40 grants the rotational operation of the ignition operational portion 10. Thus, when the passenger X rotates the ignition operational portion 10 to the steering lock cancel position (Off), where the steering lock mechanism 11 gets disabled and the rotation of the steering handle 6 is granted.

Subsequently, when the passenger X rotates the ignition operational portion 10 to the ignition start position (Start) (the engine start operation), the control unit 40 transmits the request signal A again via the antennas 33, 34. The portable device 50 carried by the passenger X receives this request signal A and then transmits the ID signal B including its own ID code again. When the control unit 40 receives the ID signal B via the receiving antenna 35 and determines again whether or not this received ID code is identical to the regular ID code (ID verification is conducted). When these codes are identical (ID verification is confirmed), the engine start is granted (the engine start control).

Next, exemplified more specific operations of the control unit 40 of the vehicle 1 and the portable device 50 will be described referring to flowcharts in FIG. 7 and other following figures.

First, in step S1 in FIG. 7, the control unit 40 determines whether IG operation is conducted or not, i.e., the ignition operational portion 10 is rotated to the ignition start position (Start) or not. When it is determined that the IG operation is conducted, the request signal A is transmitted in step S2. The portable device 50 determines whether it receives the request signal A or not in step S11. When receiving, it transmits the ID signal B including its own ID code in step S12. Then, the control sequence proceeds to an idling stop start control routine of step S13.

Meanwhile, the control unit 40 determines in step S3 whether it receives the above-described ID signal B within a specified period of time or not. When it is YES, the verification of the ID signal B is conducted, i.e., whether or not the received ID code is identical to the regular ID code is determined in step S4. Then, it is determined whether the verification of the ID signal B is confirmed or not in step S5. When it is confirmed, the engine is started in step S6. After this, the control sequence proceeds to the idling stop start control routine of step S7.

Although the verification of the ID signal B is conducted in the step S4 at the time when the ignition operational portion 10 is rotated to the ignition start position (Start) in the above-described control, the following control may be adopted. Namely, this verification of the ID signal B is conducted at the time (1) when the ignition operational portion 10 is rotated from the steering lock cancel position (Off) to the accessory ON position (Acc), (2) when the ignition operational portion 10 is rotated from the accessory ON position (Acc) to the ignition ON position (On), (3) when a specified period of time (e.g., 3 seconds) has passed while the ignition operational portion 10 is in the accessory ON position (Acc), (4) when a specified period of time (e.g., 60 seconds) has passed while the ignition operational portion 10 is in the ignition ON position (On), (5) when any door is opened from the state where all doors are in closed position, or (6) when all doors are closed from the state where any door is in opened position.

Next, the idling start stop control routine of the steps S7, S13 in FIG. 7 will be described referring to flowcharts in FIG. 8 and other figures.

First, the control unit 40 determines whether an IG stop operation is conducted or not in step S21 in FIG. 8. When it is determined that the IG stop operation is conducted, the engine is stopped in step S22 and the control sequence ends. When it is determined that the IG stop operation is not conduced, it is determined whether the idling stop is under execution or not in step S23. When that is under execution, the control sequence proceeds to step S29 in FIG. 9. When that is not under execution, it is determined in step S24 whether requirement for idling stop is met or not.

Herein, the above-described requirements for idling stop are, for example, such that the vehicle stops for a specified period of time, the parking brake is under operation, the shift lever is positioned at non-driving ranges such as P or N ranges, and the like.

When the requirements for idling stop are met in the step S24, it is determined in step S25 whether the time that has passed from the previous engine start exceeds a specified time or not. When it does not exceed, the idling stop is not executed in step S26. In this case, an idling stop off lamp is tuned on, which alarms the passenger about this state. Then, the control sequence returns to the step S21. Meanwhile, when it exceeds, the idling stop is executed in step S27. In this case, an idling stop operation lamp is tuned on, which alarms the passenger about this state. Then, a timer counter for the time passing from the previous engine start is reset in step S28, and the control sequence returns to the step S21.

Also, the control unit 40 determines in step S29 in FIG. 9 whether a battery capacity decreases below a first capacity or not. When it decreases, the control sequence proceeds to step S40 in FIG. 10. When it does not decrease, the control sequence proceeds to step S30, where it is determined whether a brake boost decreases below a first boost or not. When the brake boost decreases, the control sequence proceeds to the step S40 in FIG. 10. When it does not decrease, the control sequence proceeds to step S31, where it is determined whether or not an operation for a vehicle start is conducted by the passenger.

Herein, the above-described vehicle start operation are, for example, such that the accelerator pedal is operated, the parking brake is released, the shift lever is positioned at driving ranges such as D or R ranges, and the like.

When it is determined in the step S31 that the vehicle start operation is conducted, the request signal A is transmitted in step S32. It is determined in step S101 whether the portable device 50 receives the request signal A or not. When it receives, the portable device 50 transmits the ID signal B including its own ID code in step S102.

The control unit 40 determines in step S33 whether it receives the above-described ID signal B within a specified period of time or not. When it is YES, the verification of ID signal B is conducted in step S34. Then, it is determined whether the verification of the ID signal B is confirmed or not in step S35. When it is confirmed, it is determined whether the portable device 50 is located inside the vehicle or not in step S36. When it is located inside, the engine is started in step S37. Also, the timer counter for the time passing from the previous engine start is started in step S38, and the control sequence returns to the step S21. When the answer in the steps S33, S35 or S36 is NO, an alarm of the portable device 50 carried out is executed in step S39.

The control unit 40 starts the engine in step S40 in FIG. 10, and subsequently transmits the request signal A in step S41. The portable device 50 determines whether it receives this request signal A or not in step S103. When it receives, the portable device 50 transmits the ID signal B including its own ID code in step S104.

The control unit 40 determines in step S42 whether it receives the above-described ID signal B within a specified period of time or not. When it is YES, the verification of ID signal B is conducted in step S43. Then, it is determined whether the verification of the ID signal B is confirmed in step S44. When it is confirmed, it is determined whether the portable device 50 is located inside the vehicle or not in step S45. When it is located inside, the control sequence proceeds to step S49. When the answer in the steps S42, S44 or S45 is NO, an alarm is executed in step S46. Then, it is determined in step S47 whether the vehicle start operation is conducted or not. When the vehicle start operation is not conducted, the control sequence proceeds to the step S49. When the vehicle start operation is conducted, a vehicle start prohibition control is executed in step S48, and after that the control sequence proceeds to the step S49.

Herein, the above-described vehicle start prohibition control are, for example, controls of an engine stop, a shift change prohibition (shift lock), a cancel prohibition of brake or parking brake or the like.

Then, it is determined in step S49 whether the IG stop operation is conducted or not. When it is determined that the IG stop operation is conducted, the engine is stopped in step S50 and the control sequence ends. When it is determined that the IG stop operation is not conducted, it is determined in step S51 whether the battery capacity exceeds a second capacity or not (the second capacity has a greater value than the first capacity in the step S29). When it dost not exceed that, the control sequence returns to the step S41. When it exceeds that, it is determined in step S52 whether the brake boost exceeds a second boost or not (the second brake boost has a greater value than the first bake boost in the step S30). When it does not exceeds that, the control sequence returns to the step S41. When it exceeds that, an idling stop is executed in step S53, and after that the control sequence returns to the step S31 in FIG. 9.

As described above, according to the vehicle 1 equipped with both ISS system and SES system of the present embodiment, the engine's start (step S37) according to the vehicle start operation by the passenger X (step S31) is executed when the ID verification with the portable device 50 is confirmed (step S35). Accordingly, even if any persons who do not carry the portable device 50 get on the vehicle and try to move the vehicle 1 while the passenger X carrying the portable device 50 is out, the engine start is prohibited, thereby securing the antitheft function of the SES system properly.

Meanwhile, the engine's start (step S40) according to the emergency start requirement of the battery capacity decrease (step S29) or the brake boost decrease (step S30) is executed without the confirmation of the ID verification with the portable device 50. Accordingly, even if there occurs any problems with the verification by the portable device 50, the engine can be started properly, thereby securing the engine start function of the ISS system properly and avoiding the battery discharge or the heavy brake operation at the engine start.

Also, after the engine is automatically started according to the emergency start requirement (step S40) and when the operation for the vehicle start is conducted by the passenger X (step S47), the vehicle 1 is. prohibited from starting (step S48) when the ID verification with the portable device 50 is not confirmed (step S44). Accordingly, it can be prevented that any persons not carrying the portable device 50 starts the vehicle 1 after the emergency start requirement is met (the battery capacity decrease, the brake boost decrease, etc.), thereby securing the antitheft function of the vehicle.

Further, after the engine is automatically started according to the emergency start requirement (step S40) and when the ID verification with the portable device is not confirmed (step S44), the specified alarm is conducted (step S46). Accordingly, the passenger X can be notified in advance of a situation where the vehicle 1 may be prohibited from starting (step S48) even if the vehicle start operation is conducted by the passenger X (step S47) while the ID verification with the portable device is not confirmed (step S44). Thereby, the passenger X could be prevented from getting upset or surprised with the situation that the engine had already started but the vehicle 1 could not start (move) despite the vehicle start operation by the passenger X.

Additionally, the above-described alarm (step S46) becomes a warning that could urge any persons not carrying the portable device 50 to leave the vehicle without trying a vehicle theft, or that could request the passenger X carrying the portable device 50 to remove any possible causes of the non-confirmation of the ID verification (such as, changing position of the portable device 50 or replacing its battery 56 by a new one).

Next, the second embodiment of the idling stop start control routine of the steps S7, S13 in FIG. 7 will be described referring to a flowchart in FIG. 11. As compared with FIGS. 8-10, only a portion that corresponds to FIG. 10 is different from the previous embodiment. Accordingly, this difference will be described below.

When it is determined that the battery capacity decreases below the first capacity in the step S29 or the brake boost decreases below the first boost in step S30, the intensity of the request signal A is increased and/or the threshold of the ID signal B is decreased in step S140. Namely, a control to enhance a function of the ID verification of the portable device 50 is executed. Then, the request signal A is transmitted in step S141. It is determined in step S103 whether the portable device 50 receives this request signal A or not. When receiving, the portable device 50 transmits the ID signal B including its own ID code in step S104.

The control unit 40 determines in step S142 whether it receives the above-described ID signal B within a specified period of time or not. When it is YES, the verification of the ID signal B is conducted or not in step S143. Then, it is determined whether the verification of the ID signal B is confirmed in step S144. When it is confirmed, it is determined whether the portable device 50 is located inside the vehicle or not in step S145. When it is located inside, the engine is started in step S146. Then, it is determined in step S147 whether the vehicle start operation is conducted or not. When the vehicle start operation is conducted, the control sequence returns. When the vehicle start operation is not conducted, the control sequence proceeds to step S148. When the answer in the steps S142, S144 or S145 is NO, the alarm is executed in step S153, and then the control sequence returns.

Then, it is determined in step S148 whether the IG stop operation is conducted or not. When it is determined that the IG stop operation is conducted, the engine is stopped in step S149 and the control sequence ends. When it is determined that the IG stop operation is not conducted, it is determined in step 150 whether the battery capacity exceeds the second capacity or not (the second capacity has the greater value than the first capacity in the step S29). When it dost not exceed that, the control sequence returns to the step S141. When it exceeds that, it is determined in step S151 whether the brake boost exceeds the second boost or not (the second brake boost has the greater value than the first bake boost in the step S30). When it does not exceeds that, the control sequence returns to the step S141. When it exceeds that, the idling stop is executed in step S152, and after that the control sequence returns to the step S31 in FIG. 9.

As described above, according to the device of the second embodiment, which is different from the first embodiment in FIGS. 8-10, the engine's start (step S146) according to the emergency start requirement (step S29, S30) is also executed with the confirmation of the ID verification with the portable device 50 (step S144). Thereby, the antitheft function of the SES system can be strengthened further compared with the first embodiment.

In the above-described embodiment, when it is determined that the operation for the vehicle start is conducted in step S147 in FIG. 11, the control sequence may return to the step S31 in FIG. 9 as shown by a broken line. With the verification of the passenger, the vehicle antitheft function may be further improved.

Next, the third embodiment of the idling stop start control routine will be described referring to flowcharts in FIGS. 12 and 13.

When the battery capacity decreases below the first capacity in the step S29 or the brake boost decreases below the first boost in the step S30 in FIG. 9, the control sequence proceeds to step S240 in FIG. 12, where the unit 40 determines whether a cancel switch operation is conducted or not. When the cancel switch is not operated, it is determined in step S241 whether the passenger is in the vehicle or not. When the passenger is not, the control unit 40 transmits the request signal A in step S242. The portable device 50 determines in step S103 whether it receives the above-described request signal A or not. When it receives the signal, the portable device 50 transmits the ID signal B including its own code in the step S104.

Herein, the cancel switch operation in the step S240 is effective for a specified period of time, i.e., until the IG stop operation is conduced. Also, the determination that the passenger is in the vehicle in the step S241 is considered to be made when any door's opening is not detected by the door opening detecting sensor 26 after the start of the idling stop execution, when the motion sensor 18 detects something, when the sitting weight sensor 19 outputs its weight-detecting signal, or when any switch's operation of the electric-device unit 20 is operated.

Next, the control unit 40 determines in step S243 whether it receives the above-described ID signal B within a specified period of time or not. When it is YES, the verification of the ID signal B is conducted in step S244. Then, it is determined whether the verification of the ID signal B is confirmed or not in step S245. When it is confirmed, it is determined whether the portable device 50 is located inside the vehicle or not in step S246. When it is located inside, the control sequence proceeds to step S247 in FIG. 13, where the engine is started. Herein, when any operation of the electric device has been restricted in step S253, which will described below, this restriction is canceled in this step S247. Meanwhile, the answer in the steps S243, S245 or S246 is NO, the alarm is executed in the vehicle for a specified period of time in step S251 in FIG. 13, and then it is determined in step S252 whether the battery capacity decreases below a third capacity or not (the third capacity has a smaller value than the first capacity in the step S29). When it decrease below that, the operation of electric device is restricted in step S253, and then the control sequence returns to the step S240, where it is determined whether the cancel switch operation is conducted or not. Meanwhile, it does not decrease below that, the control sequence returns to the step S240, where it is determined whether the cancel switch operation is conducted or not, likewise.

Then, it is determined in step S248 in FIG. 13 whether the vehicle start operation is conducted or not. When the vehicle start operation is not conducted, it is determined in step S249 whether the IG stop operation is conducted or not. When it is determined that the IG stop operation is conducted, the engine is stopped in step S250 and the control sequence ends. When it is determined that the IG stop operation is not conducted, it is determined in step 254 whether the battery capacity becomes below the second capacity or not. When it dost not become below that, it is determined in step S255 whether the brake boost becomes below the second boost or not (the second brake boost has the greater value than the first bake boost in the step S30). When it does not become below that, the idling stop is executed in step S256, and after that the control sequence returns to the step S31 in FIG. 9. When the vehicle start operation is conducted in the step S248, the control sequence returns to the step S31. Also, when the answer is YES in the steps S254, S255, the control sequence returns to the step S240 in FIG. 12.

As described above, according to the vehicle 1 equipped with both ISS system and SES system of the third embodiment, when the passenger's existence in the vehicle is detected during the idling stop execution by the passenger detecting device, such as the motion sensor 18, sitting-weight detecting sensor 19, switch of the electric-device unit 20, door opening detecting sensor 26 and the like (step S241), the engine's started is granted without the confirmation of the ID verification with the portable device 50 (step S247). Accordingly, even if there occurs any problems with the verification by the portable device 50, the engine can be started surely as long as the passenger X is in the vehicle.

Meanwhile, when the passenger's existence in the vehicle is not detected by the passenger detecting device 18, 19, 20, 26 . . . (step S241), when the control unit 40 does not receive the ID signal B from the portable device 50 within the specified period of time after transmitting of the request signal A (step S243), when the verification of ID signal B verification can not be confirmed even if it receives the ID signal B (step S245), or when the portable device 50 is not located in the vehicle (step S246), the alarm is executed by the warning lamp and buzzer 28 in the vehicle for the specified period of time (step S251). Accordingly, the engine staring is restricted, so that the engine can be prevented from being started automatically when passenger's existence is not detected after the passenger X carrying the portable device 50 gets off the vehicle. Thus, the antitheft function of the SES system can be improved.

Further, since the operation of the onboard electric device is restricted when the engine start is restricted (step S253), the battery discharge can be avoided properly in advance. Herein, the step S252 can be omitted.

Also, when the passenger's existence in the vehicle is not detected by the passenger detecting device 18, 19, 20, 26 . . . (step S241), the engine start is granted on the condition of the confirmation of ID verification with the portable device 50 (step S247). Namely, even if any malfunctions or detecting mistakes would happen to the passenger detecting device 18, 19, 20, 26 . . . , a situation where the engine can not be started with the vehicle start operation by the passenger X during, for example, a vehicle stop for waiting for the light changed, can be prevented from happening. Also, even if any malfunctions or detecting mistakes would happen to the passenger detecting device 18, 19, 20, 26 . . . and thereby the passenger's existence in the vehicle is not detected, the engine start is granted as long as the ID verification with the portable device 50 is confirmed. Thereby, the battery discharge can be prevented, thereby securing the operation of the onboard electric devices, and the brake boost can be prevented from decreasing inappropriately. Herein, since the ID verification has been confirmed, the grant of engine start would not cause the vehicle-theft problem.

Further, since there is provided the cancel switch 21 to cancel restrictions of the engine start and the onboard-electric-device operation by the control unit 40, the engine can be operated (step S247) by the passenger X operating this cancel switch 21. Thereby, even in a case, for example, where the passenger X goes out of the vehicle and the onboard electric devices, such as audio device, some equipment connected to cigar-lighter outlet via a cable, are used for a long time, the operation of these devices can be attained properly with the function of the cancel switch 21 and the utility of the vehicle can be improved.

The present invention should not be limited to the above-described embodiments, but any other modifications and improvements may be applied within the scope of a sprit of the present invention as defined by the claims.

What is claimed is:

1. A control system for a vehicle, comprising:
a smart engine starter control device, in which a start of an engine of the vehicle is granted when ID verification with a portable device operative to exchange wireless signals is confirmed in a case where an operation for an engine start is conducted by a passenger; and
an idling stop start control device, in which the engine is automatically stopped when the vehicle is stopped and automatically started in a case where an operation for a vehicle start is conducted by the passenger or a specified emergency start is required,
wherein said idling stop start control device is configured such that in the case where the operation for the vehicle start is conducted by the passenger, the engine is automatically started at least when the ID verification with the portable device is confirmed, and in the case where the specified emergency start is required, the engine is automatically started without the confirmation of the ID verification with the portable device or on a condition of the confirmation of the ID verification along with a specified control to enhance a function of the ID verification.

2. The control system for a vehicle of claim 1, wherein said idling stop start control device is configured such that the engine is automatically started without the confirmation of the ID verification with the portable device in the case where the specified emergency start is required.

3. The control system for a vehicle of claim 2, wherein said idling stop start control device is configured such that after the engine is automatically started according to the requirement of the specified emergency start and in the case where the operation for the vehicle start is conducted by the passenger, the vehicle is prohibited from starting when the ID verification with the portable device is not confirmed.

4. The control system for a vehicle of claim 3, wherein said idling stop start control device is configured such that after the engine is automatically started according to the requirement of the specified emergency start and when the ID verification with the portable device is not confirmed, a specified alarm is conducted.

5. The control system for a vehicle of claim 2, wherein there is further provided a passenger detecting device to detect an existence of the passenger in the vehicle, and said idling stop start control device is configured such that the engine start according to the requirement of the specified emergency start is restricted when the passenger's existence is not detected by the passenger detecting device.

6. The control system for a vehicle of claim 5, wherein said idling stop start control device is configured such that an operation of an onboard electric device is restricted when the engine start is restricted.

7. The control system for a vehicle of claim 5, wherein said idling stop start control device is configured such that when the passenger's existence is not detected by the passenger detecting device, the engine start is granted on a condition of the confirmation of the ID verification with the portable device.

8. The control system for a vehicle of claim 6, wherein there is further provided a restriction cancel device to cancel restrictions of the engine start and the onboard-electric-device operation, which is to be operated by the passenger.

9. The control system for a vehicle of claim 1, wherein said idling stop start control device is configured such that the engine is automatically started on the condition of the confirmation of the ID verification along with the specified control to enhance the function of the ID verification.

10. The control system for a vehicle of claim 9, wherein said specified control to enhance the function of the ID verification comprises at least one of a signal-intensity increase control and a signal-threshold decrease control for the exchanged wireless signals of the portable device.
